(19) United States
(12) Patent Application Publication
(10) Pub. No.: US 2018/0011772 A1
(43) Pub. Date: Jan. 11, 2018

(54) PERIPHERAL DEVICE OPERATION

(71) Applicant: HEWLETT-PACKARD DEVELOPMENT COMPANY, L.P., HOUSTON, TX (US)

(72) Inventors: JEREMY MEYER, HOUSTON, TX (US); JAMES M MANN, HOUSTON, TX (US); MADHU SUD ATHREYA, PALO ALTO, CA (US)

(21) Appl. No.: 15/542,814

(22) PCT Filed: Mar. 31, 2015
(86) PCT No.: PCT/US15/23595

§ 371 Date: Jul. 11, 2017

(51) Int. Cl. G06F 11/30; G06F 13/38

(52) U.S. Cl. CPC G06F 11/3051; G06F 13/385

(57) ABSTRACT

Example implementations relate to peripheral device operation. For example, a peripheral device may include a processor. The processor may detect that a computing device is in communication with the peripheral device and send peripheral device information to the computing device. The peripheral device information may specify characteristics associated with the peripheral device including a purpose, capability, and context of the peripheral device. The processor may receive operational data from the computing device, where the operational data may be based on the peripheral device information and may indicate a manner of operating the peripheral device. The processor may perform an operation based on the operational data.

### BACKGROUND

A computing device may connect to various types of accessories, and those accessories may operate in conjunction with the computing device. For example, a computing device may connect to a keyboard accessory, and the keyboard accessory may be used to provide inputs to the computing device.

### BRIEF DESCRIPTION OF THE DRAWINGS

Some examples of the present application are described with respect to the following figures:

FIG. 1 is a block diagram of an example system for operating a peripheral device;

FIG. 2 is a block diagram of an example peripheral device that may perform operations based on peripheral device information; and

FIG. 3 is a flowchart of an example method for operating a peripheral device.

### DETAILED DESCRIPTION

As described above, a computing device may connect to various types of accessories that may be peripheral devices to the computing device. When a peripheral device is connected to a computing device, the peripheral device may send information to a computing device, where that information may be limited to technical specifications and features. For example, in the case of a peripheral device that is a display, the information sent to a computing device in communication with the display may be limited to resolution options, color depth, aspect ratio, or orientation of the display. This may be used by the computing device to properly configure the display adapter settings of the computing device such that the computing device may use the display. However, the computing device may have no information associated with the intended purpose of the display, and the computing device may not be able to understand the various ways to present information on the display. In another example, when a smartphone connects to a display in an automobile, the smartphone may know how to format content such that it may be displayed on the automobile's display, but the smartphone may not understand that there are touch controls or hardware buttons available on the display, that there are speech capabilities on the display, that the display is a heads-up display versus a center console display or a backseat display, and the like. As such, the smartphone may not be maximizing the capabilities of the automobile display.

To maximize the features of peripheral devices, a peripheral device may send peripheral device information to a computing device upon detecting that the peripheral device is connected to the computing device. The peripheral device information may be any suitable information specifying any characteristics associated with the peripheral device. For example, the peripheral device information may specify one or more purposes of the peripheral device that indicate an intended use of the peripheral device. The peripheral device information may also specify one or more capabilities of the peripheral device that indicate the various features of the peripheral device and the various manners in which the peripheral device may operate (e.g., the type of peripheral device, specifications associated with the peripheral device, configuration options, parameters, touch screen capabilities, voice-activated capabilities, etc.). The peripheral device information may also specify a context of the peripheral device, where the context may indicate any characteristics of the peripheral device with respect to any suitable factors, such as a date, a time, a geographic location of the peripheral device, a movement of the peripheral device, a state of the peripheral device, an environment of the peripheral device (e.g., a television in a hotel room versus in a living room or in a workplace), and the like. The peripheral device information may be used by the computing device such that the computing device may operate the peripheral device based on the peripheral device information (e.g., based on the peripheral device's intended purpose, capabilities, and/or context), allowing the computing device to make more intelligent decisions about how to interact with the various peripheral devices with which it may communicate. For example, the computing device may use the peripheral device information to send operational data to the peripheral device, where the operational data may indicate a manner of operating the peripheral device based on the peripheral device data.

For example, a computing device may communicate with various peripheral device each having different intended purposes, capabilities, and/or contexts. The peripheral device information associated with each of the peripheral devices may be used by the computing device to understand the technical specifications of each peripheral device, as well as what can potentially be done with each peripheral device, how the user might interact with each of the peripheral devices, how changes to the context of each peripheral device may change how a user interacts with the peripheral device, and the like. For example, in a car display situation, a computing device may choose to display different information in a different format when the car is moving versus when the car is stationary, or the computing device may choose to display different content to different displays within a car (e.g., based on whether the display is a heads-up display, a main console display, or a backseat display). The computing device may analyze the peripheral device information using an algorithm to determine the manner of interacting with the peripheral device. In some examples, this algorithm may incorporate a policy manager in which a user (e.g., an administrator) may enforce or suggest certain behaviors and interaction modalities depending on the context of the peripheral device.

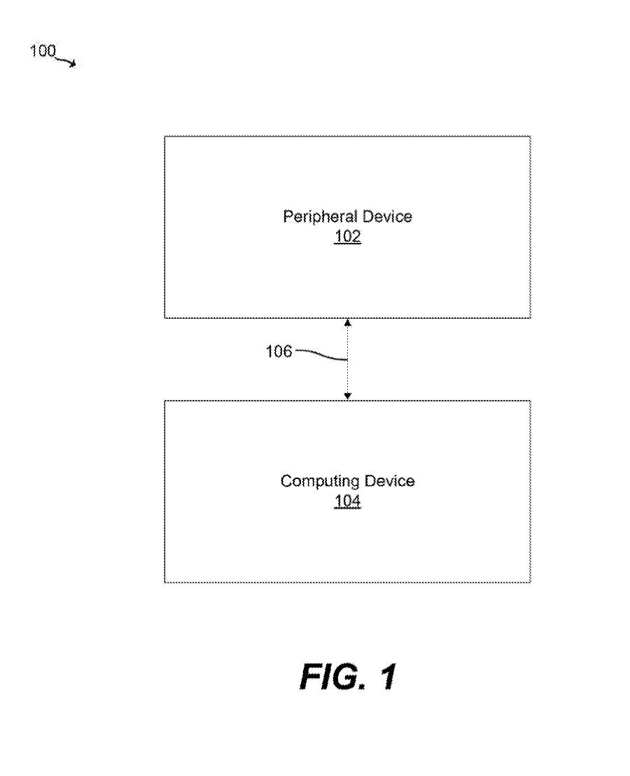

Referring now to the figures, FIG. 1 is a block diagram of an example system 100 for operating a peripheral device. System 100 may include peripheral device 102, which may be any type of peripheral device, such as a display, an automobile device (e.g., a console device), a wearable device (e.g., a smart watch), a tablet, a projector, a keyboard, a mouse, a gesture recognition device, a dock, a camera, a microphone, a speaker, a television, a storage device, a scanner, a printer, a fax machine, a biometric reader, a biometric sensor, a communication device, and the like. Peripheral device 102 may be in communication with computing device 104, which may be any suitable computing device, such as a notebook computer, a desktop computer, an all-in-one system, a tablet computing device, a mobile phone, a smart phone, an electronic book reader, a printing device, or any other electronic device suitable for operating peripheral device 102. Peripheral device 102 and computing device 104 may be in communication with each other via connection 106, which may be any suitable connection such as via a wired connection or a wireless connection (e.g., Bluetooth).

Peripheral device 102 may be any suitable peripheral device that may identify that computing device 104 is in communication with peripheral device 102 (e.g., via connection 106). Peripheral device 102 may transmit peripheral device information to computing device 104 (e.g., via connection 106). The peripheral device information may include any suitable information specifying any characteristics associated with peripheral device 102, such as a purpose, capability, and context of peripheral device 102. For example, peripheral device 102 may send peripheral device information that may include any one or more of a type associated with peripheral device 102 (e.g., whether peripheral device 102 is a keyboard, mouse, etc.), specifications associated with peripheral device 102, a date, a time, a geographic location of peripheral device 102, a movement of peripheral device 102, a state of peripheral device 102, an environment of peripheral device 102, and the like. Peripheral device 102 may receive operational data from computing device 104, where the operational data may be based on the peripheral device information and may indicate a manner of operating peripheral device 102. Peripheral device 102 may perform an operation based on the operational data. In some examples, peripheral device 102 may determine a change in the context of peripheral device 102, receive subsequent operational data from computing device 104 based on the change and the peripheral device information, and perform a subsequent operation based on the subsequent operational data. In some examples, the change in the context may be detected by peripheral device 102 and/or computing device 104.

In some examples, system 100 of FIG. 1 may include one or more sensors to detect the context associated with peripheral device 102 and/or any changes to the context. The one or more sensors may be part of peripheral device 102, computing device 104, and/or may be external to both peripheral device 102 and computing device 104.

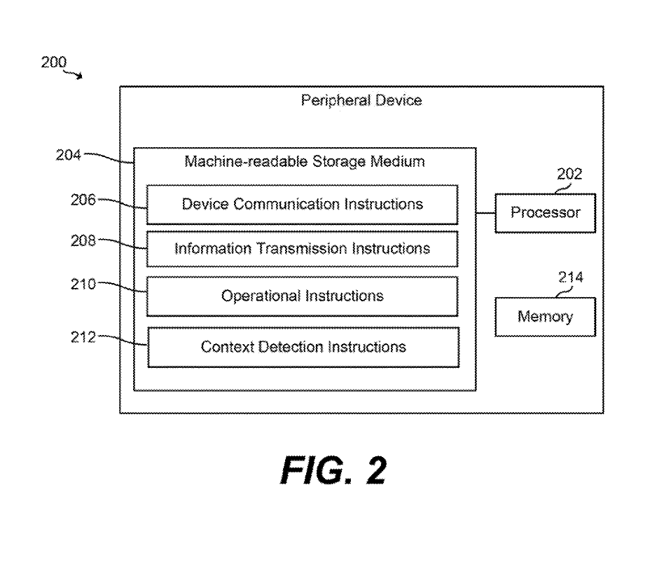

FIG. 2 is a block diagram of an example peripheral device 200 that may perform operations based on peripheral device information. Peripheral device 200 may be any suitable device (e.g., peripheral device 102 of FIG. 1) that may send peripheral device information to a computing device in communication with peripheral device 200 such that the computing device may operate peripheral device 200 based on the peripheral device information.

Peripheral device 200 may be, for example, a display, an automobile device (e.g., a console device), a wearable device (e.g., a smart watch), a tablet, a projector, a keyboard, a mouse, a gesture recognition device, a clock, a camera, a microphone, a speaker, a television, a storage device, a scanner, a printer, a fax machine, a biometric reader, a biometric sensor, a communication device, or any other electronic device suitable for performing operations based on peripheral device information. Peripheral device 200 may include a processor 202 and a machine-readable storage medium 204. Peripheral device 200 may detect that a computing device is in communication with peripheral device 200, send peripheral device information to the computing device, and perform an operation based on operational data received from the computing device, where the operational data is based on the peripheral device information.

Processor 202 is a tangible hardware component that may be a central processing unit (CPU), a semiconductor-based microprocessor, and/or other hardware devices suitable for retrieval and execution of instructions stored in machine-readable storage medium 204. Processor 202 may fetch, decode, and execute instructions 206, 208, 210, and 212 to control a process of performing operations based on peripheral device information. As an alternative or in addition to retrieving and executing instructions, processor 202 may include at least one electronic circuit that includes electronic components for performing the functionality of instructions 206, 208, 210, 212, or a combination thereof.

Machine-readable storage medium 204 may be any electronic, magnetic, optical, or other physical storage device that contains or stores executable instructions. Thus, machine-readable storage medium 204 may be, for example, Random Access Memory (RAM), an EPROM, an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with a series of processor executable instructions 206, 208, 210, and 212 for detecting that a computing device is in communication with peripheral device 200; sending peripheral device information to the computing device, the peripheral device information specifying characteristics associated with peripheral device 200 including a purpose, capability, and context of peripheral device 200; receiving operational data from the computing device, the operational data being based on the peripheral device information and indicating a manner of operating peripheral device 200; and performing an operation based on the operational data.

Device communication instructions 206 may manage and control the detection of a computing device in communication with peripheral device 200. For example, after peripheral device 200 is initially connected to a computing device (e.g., via a wired or a wireless connection), device communication instructions 206 may detect the connection.

Information transmission instructions 208 may manage and control the transmission of peripheral device information to the computing device in response to detecting the connection to the computing device. For example, information transmission instructions 208 may send peripheral device information to the computing device, where the peripheral device information may specify any suitable characteristics associated with peripheral device 200 including a purpose, capability, and context of peripheral device 200. Peripheral device information may include any suitable information that may be used to operate peripheral device 200, such as any one or more of a type associated with peripheral device 200 (e.g., whether peripheral device 200 is a keyboard, mouse, etc.), specifications associated with peripheral device 102, a date, a time, a geographic location of peripheral device 200, a movement of peripheral device 200, a state of peripheral device 200, an environment of peripheral device 200, and the like. The peripheral device information may be stored in memory 214, which may be any suitable type of memory. Information transmission instructions 208 may access the peripheral device information from memory 214 and may send the accessed memory to the computing device.

Operational instructions 210 may manage and control the operation of peripheral device 200. Operational instructions 210 may receive operational data from the computing device, where the operational data may be based on the peripheral device information sent to the computing device and may indicate a manner of operating peripheral device 200. For example, operational instructions 201 may receive operational data that indicates information to be displayed on peripheral device 200, where the operational data may be based on peripheral device information that specified that peripheral device 200 was capable of displaying information. Operational instructions 210 may perform an operation (e.g., displaying information) based on the operational data received from the computing device.

Context detection instructions 212 may manage and control the detection of a context associated with peripheral device 200. A context of peripheral device 200 may include any information that specifies a context of peripheral device 200 with respect to any various factors. Examples of the context of peripheral device 200 includes a date, a time, a geographic location of peripheral device 200, a movement of peripheral device 200, a state of peripheral device 200, an environment of peripheral device 200, and the like. Context detection instructions 212 may also detect any changes in the context of peripheral device 200 (e.g., via one or more sensors associated with peripheral device 200). For example, context detection instructions 212 may detect that peripheral device 200 has changed from being stationary to moving (e.g., a console in an automobile that has changed from being parked to being driven).

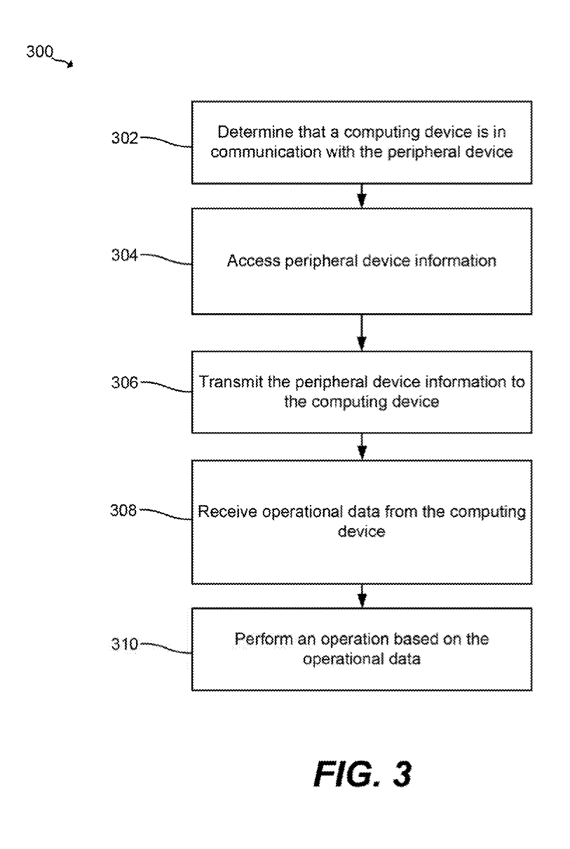

FIG. 3 is a flowchart of an example method 300 for operating a peripheral device. Method 300 may be implemented using peripheral device 102 of FIG. 1 and/or peripheral device 200 of FIG. 2.

Method 300 includes, at 302, determining that a computing device (e.g., computing device 104 of FIG. 1) is in communication with the peripheral device. For example, the peripheral device may detect a connection (e.g., wired or wireless) to a computing device.

Method 300 also includes, at 304, accessing peripheral device information stored on the peripheral device. The peripheral device information may be any suitable information specifying any characteristics associated with the peripheral device including a purpose, capability, and context of the peripheral device.

Method 300 also includes, at 306, transmitting the peripheral device information to the computing device. The accessed peripheral device information, or at least a subset of the peripheral device information, may be transmitted to the computing device. In some examples, the peripheral device information may be transmitted to the computing device in response to determining that the peripheral device is connected to the computing device.

Method 300 also includes, at 308, receiving operational data from the computing device. The operational data may be based on the peripheral device information transmitted to the computing device and may indicate a manner of operating the peripheral device based on the peripheral device information.

Method 300 also includes, at 310, performing an operation based on the operational data. For example, the peripheral device information sent to the computing device may cause the computing device to send operational data that indicates that the peripheral device is to perform an operation that includes outputting audio, where the peripheral device information specifies the peripheral device's audio capabilities.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and the like.

What is claimed is:

1. A peripheral device, comprising:
a processor to:
detect that a computing device is in communication with the peripheral device;
send peripheral device information to the computing device, the peripheral device information specifying characteristics associated with the peripheral device including a purpose, capability, and context of the peripheral device;
receive operational data from the computing device, the operational data being based on the peripheral device information and indicating a manner of operating the peripheral device; and
perform an operation based on the operational data.

2. The peripheral device of claim 1, wherein the peripheral device is a display, an automobile device, a wearable device, a tablet, a projector, a keyboard, a mouse, a gesture recognition device, a clock, a camera, a microphone, a speaker, a television, a storage device, a scanner, a printer, a fax machine, a biometric reader, a biometric sensor, or a communication device.

3. The peripheral device of claim 1, wherein the peripheral device information includes at least one of a type of the peripheral device, specifications associated with the peripheral device, a date, a time, a geographic location of the peripheral device, a movement of the peripheral device, and a state of the peripheral device.

4. The peripheral device of claim 1, wherein the processor is further to:
determine a change in the context of the peripheral device;
receive, from the computing device, subsequent operational data based on the change and the peripheral device information; and
perform a subsequent operation based on the subsequent operational data.

5. The peripheral device of claim 4, wherein the change in the context is detected by the peripheral device or the computing device.

6. The computing device of claim 1, wherein the computing device is in communication with the peripheral device over a wired or a wireless connection.

7. A method, comprising:
determining, by a peripheral device, that a computing device is in communication with the peripheral device;
accessing, by the peripheral device, peripheral device information associated with the peripheral device, the peripheral device information specifying characteristics associated with the peripheral device including a purpose, capability, and context of the peripheral device;
transmitting, by the peripheral device, the peripheral device information to the computing device;
receiving, by the peripheral device, operational data from the computing device, the operational data being based on the peripheral device information and indicating a manner of operating the peripheral device; and
performing, by the peripheral device, an operation based on the operational data.

8. The method of claim 7, wherein the peripheral device is a display, an automobile device, a wearable device, a tablet, a projector, a keyboard, a mouse, a gesture recognition device, a clock, a camera, a microphone, a speaker, a television, a storage device, a scanner, a printer, a fax machine, a biometric reader, a biometric sensor, or a communication device.

9. The method of claim 7, wherein the peripheral device information includes at least one of a type of the peripheral device, specifications associated with the peripheral device, a date, a time, a geographic location of the peripheral device, a movement of the peripheral device, and a state of the peripheral device.

10. The method of claim 7, further comprising:
determining, by the peripheral device, a change in the context of the peripheral device;
receiving, by the peripheral device, subsequent operation data from the computing device, the subsequent operational data being based on the change and the peripheral device information; and
performing, by the peripheral device, a subsequent operation based on the subsequent operational data.

11. The method of claim 10, wherein the change in the context is detected by the peripheral device or the computing device.

12. A non-transitory machine-readable storage medium storing instructions that, when executed by at least one processor of a peripheral device, cause the peripheral device to:
identify that a computing device is in communication with the peripheral device;
transmit peripheral device information to the computing device, the peripheral device information specifying characteristics associated with the peripheral device including a purpose, capability, and context of the peripheral device;
receive operational data from the computing device, the operational data being based on the peripheral device information and indicating a manner of operating the peripheral device; and
perform an operation based on the operational data.

13. The non-transitory machine-readable storage medium of claim 12, wherein the peripheral device is a display, an automobile device, a wearable device, a tablet, a projector, a keyboard, a mouse, a gesture recognition device, a clock, a camera, a microphone, a speaker, a television, a storage device, a scanner, a printer, a fax machine, a biometric reader, a biometric sensor, or a communication device.

14. The non-transitory machine-readable storage medium of claim 12, wherein the peripheral device information includes at least one of a type of the peripheral device, specifications associated with the peripheral device, a date, a time, a geographic location of the peripheral device, a movement of the peripheral device, and a state of the peripheral device.

15. The non-transitory machine-readable storage medium of claim 12, wherein the instructions further cause the peripheral device to:
determine a change in the context of the peripheral device;
receive, from the computing device, subsequent operational data based on the change and the peripheral device information; and
perform a subsequent operation based on the subsequent operational data.
